(19) United States
(12) Patent Application Publication
(10) Pub. No.: US 2008/0284800 A1
(43) Pub. Date: Nov. 20, 2008

(54) Method and/or apparatus for displaying scaled design drawings permitting measurement directly from the display

(76) Inventor: Jared Ross, Gaithersburg, MD (US)

Correspondence Address: NIXON & VANDERHYE, PC, 901 NORTH GLEBE ROAD, 11TH FLOOR, ARLINGTON, VA, 22203, US

(21) Appl. No.: 11/798,623

(22) Filed: May 15, 2007

(51) Int. Cl. G09G 5/373

(52) U.S. Cl. 345/661

(57) ABSTRACT

Certain example embodiments of this invention relate to a display device. The display device may comprise a display capable of displaying at least one design drawing. At least one storage location may be capable of storing at least one design drawing to be displayed. Display programmed logic circuitry may be capable of causing the display to display the at least one design drawing based at least in part on one or more scale parameters, such that the at least one design drawing is displayed on the display so as to allow measurements to be taken directly from the display. The displayed design drawing may be altered by means of a user interface to adjust, for example, the scale, viewable area, rotation, etc. The display device may portable, and it may useful for deployment in, for example, the engineering, real estate, mapping, surveying, construction, and other fields.

### FIELD OF THE INVENTION

Certain example embodiments of this invention relate to techniques for displaying scaled images. More particularly, certain example embodiments of this invention relate to methods and/or apparatuses for displaying scaled images (e.g., detailed design drawings such as, for example, specifications, technical schematics, maps, schematics, architectural drawings, landscape, survey, and the like) on a device (e.g., a portable electronic device), such that measurements may be taken directly from the display of the device.

### BACKGROUND AND SUMMARY OF EXAMPLE EMBODIMENTS OF THE INVENTION

Specifications, technical schematics, maps, schematics, landscapes, surveys, architectural drawings, and other similar detailed design drawings require precise measurement to ensure, for example, adequate construction, surveying, etc., in the engineering, real estate, mapping, surveying, construction, and other fields. Even a small error caused by an inaccurate measurement, improper scale, etc. may have serious impacts on the final product, whether that product is a house, office building, land survey, or the like.

Conventionally, specifications, technical schematics, maps, schematics, landscapes, surveys, architectural drawings, and the like are drawn to scale when they are initially created. For example, computer-aided design (CAD) systems have been used to produce architectural drawings, and computer-aided manufacturing (CAM) systems have been used to produce product components. Regardless of the system used for creating such drawings, typically one or more to-scale design drawings are printed out. Then, appropriate personnel (e.g., carpenters, foremen, landscapers, surveyors, etc.) take measurements directly from the printouts.

Unfortunately, these conventional techniques suffer from several disadvantages. For example, detailed drawings typically are large and burdensome to carry around. This is true, for example, when a workman or foreman travels from site-to-site and must carry a number of different drawings. Similarly, printouts also are difficult to use. For example, a suitable flat workspace must be found, drawings typically must be unrolled or unfolded for use and then re-rolled or folded when done, etc. Such printouts also create a significant amount of wasted paper, thus wasting time and money.

Thus, it will be appreciated that there exists a need for improved techniques for taking measurements from design drawings.

One aspect of certain example embodiments of this invention relates to techniques for displaying scaled detailed design drawings such as, for example, specifications, maps, schematics, landscapes, surveys, architectural drawings, and the like on a device (e.g., a portable electronic device), such that measurements may be taken directly from the display of the device.

Another aspect of certain example embodiments relates to a user customizable scale for displaying such images.

In certain example embodiments of this invention, there is provided a display device. The display device may comprise a display capable of displaying at least one design drawing. At least one storage location may be capable of storing at least one design drawing to be displayed on the display. Display programmed logic circuitry may be capable of causing the display to display the at least one design drawing based at least in part on one or more scale parameters, such that the at least one design drawing is displayed so as to allow measurements to be taken directly from the display.

The display of the design drawing may be altered by means of a user interface to adjust, for example, the scale, viewable area, rotation, etc. One or more design drawings may be provided to the display device by means of a removable or non-removable computer-readable storage medium, and/or via a computer connection to a port of the display device.

In certain other example embodiments of this invention, there is provided a method of displaying at least one design drawing on the display of a device. The at least one design drawing may be received. Scale parameters including at least the size of the display, scale at which the design drawing is to be displayed, and scale data of the at least one design drawing may be determined or provided. Display parameters may be calculated. The design drawing may be displayed on the display based at least in part on the display parameters such that the at least one design drawing is displayed on the display so as to allow measurements to be taken directly from the display. Optionally, the display may be updated based at least in part on user input.

In still other example embodiments of this invention, there is provided a computer-readable storage medium. At least one design drawing may be stored thereon. Additionally, scale parameters for each said design drawing may be stored thereon. Based at least in part on the at least one design drawing and the scale parameters, a device capable of reading the computer-readable storage medium may be capable of causing a display of the device to display the at least one design drawing such that measurements can be taken directly from the display. The computer-readable storage medium may be updatable.

These aspects and example embodiments may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is an illustrative view of a device for displaying images to scale such that measurements may be taken directly from the display of the device, in accordance with an example embodiment;

FIG. 2 is an illustrative partial schematic view of a device for displaying images to scale such that measurements may be taken directly from the display of the device, in accordance with an example embodiment;

FIG. 3 is an illustrative flowchart for displaying images to scale such that measurements may be taken directly from the display of a device, in accordance with an example embodiment;

FIG. 4 is an illustrative flowchart for updating images displayed to scale such that measurements may be taken directly from the display of a device, in accordance with an example embodiment;

FIG. 5 is an illustrative view of a housing plan displayed on a device such that measurements may be taken directly therefrom, in accordance with an example embodiment; and,

FIG. 6 is another illustrative view of a housing plan displayed on a device such that measurements may be taken directly therefrom, in accordance with an example embodiment.

### DETAILED DESCRIPTION OF EXAMPLE EMBODIMENTS OF THE INVENTION

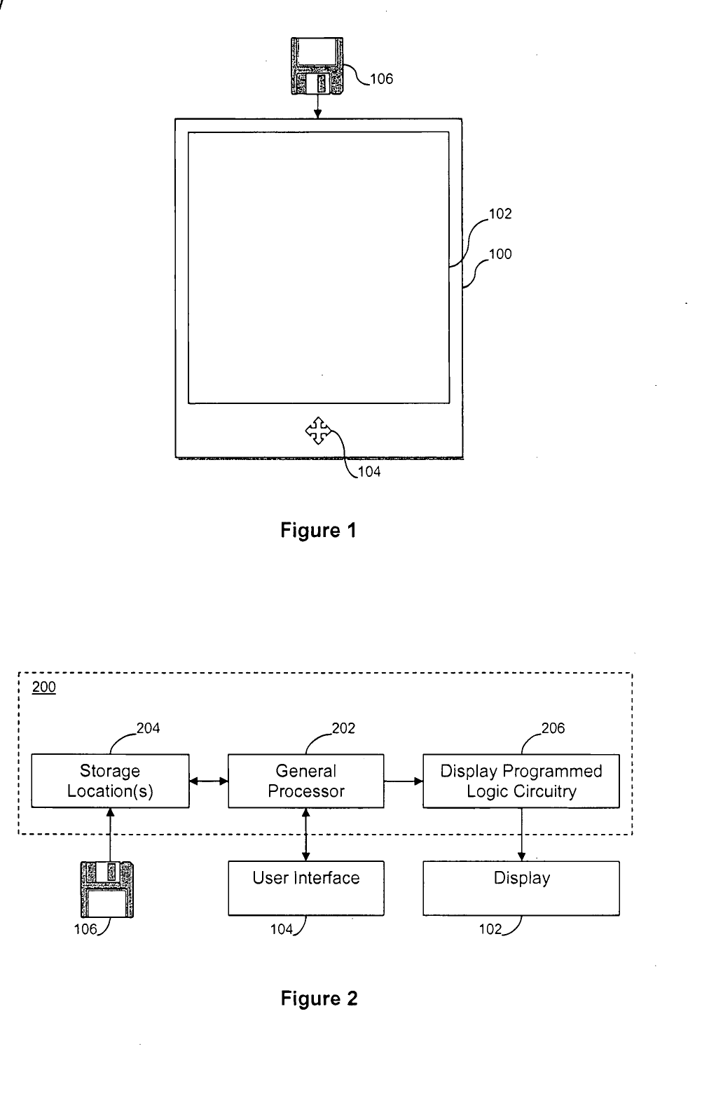

Referring now more particularly to the drawings, FIG. 1 is an illustrative view of a device 100 for displaying images to scale such that measurements may be taken directly from the display 102 of the device 100, in accordance with an example embodiment. As shown in FIG. 1, the device 100 optionally is portable and small in size, which may allow for efficient site and/or field work. The device 100 includes a display 102, which may be any display suitable for outputting detailed design drawings with a resolution sufficient to permit measurements to be taken directly from the display. Optionally, the display may be a low-power consumption display such as, for example, a slow-refreshing or bistable display, the latter of which generally draws power only when the display is changed and continues to show an image after a device is powered down.

A user interface 104 is provided to the device 100. The user interface 104 may, for example, help to enable the user to scale or rescale the design drawing. Because the design drawing usually will be bigger than the actual display 102 on which it is displayed (for example, because it is initially bigger or because its scale has been changed), the user interface 104 may enable the design drawing to be “moved” or, in other words, the user interface 104 may enable the user to focus the display 102 on various portions of the entire design drawing, effectively changing the viewable area. Similarly, the design drawing may be rotated. The user interface 104 also may enable the user to switch between multiple design drawings accessible by and/or stored on the device 100, input parameters about a design drawing (e.g., name or other identifying information, original size and/or scale of the design drawing, size of the device 100, default scales, etc.), etc. As shown in FIG. 1, the user interface includes a cross-switch (e.g., arrows pointing in four directions), although the present invention is not limited to only a cross-switch. For example, the user interface 104 may include, for example, buttons, a mouse, keyboard, trackball, scrolling wheel, touch pad, etc. Also, the display 102 may be a touch screen display, and thus may be said to at least partially comprise the user interface 104.

One or more design drawings and/or other data may be loaded into the device 100 via a computer-readable storage medium 106. The computer-readable storage medium 106 may be, for example, a flash card, SD card, USB device, etc. The computer-readable storage medium 106 may store one or more representations of the design drawing(s) in a computer-readable image format (e.g., JPEG, GIF, BMP, TIFF, etc.), as line art, vector-based images, in a proprietary format, as a PDF document, or in any other suitable format(s). As noted above, the drawing(s) may have information associated therewith such as, for example, a name or other identifying information, original size and/or scale of the design drawing, size of the device 100, default scales, etc. Although the computer readable storage medium 106 is shown as being removable, the invention is not so limited. For example, similar information may be provided to the device 100 via a computer link (e.g., a USB cable, parallel cable, serial cable, Ethernet connection, etc.) to a port provided to the device 100 and then stored in one or more storage locations of the device 100. In certain example embodiments, the device 100 may be configured to receive one or more design drawing(s) from a network source (e.g., via a wireless connection to the Internet, a proprietary network, etc.).

FIG. 2 is an illustrative partial schematic view of a device for displaying images to scale such that measurements may be taken directly from the display 102 of the device 104, in accordance with an example embodiment. The internal device 200 may include a processor 202, one or more storage locations 204, and display programmed logic circuitry 206. The processor 202 may read information from the storage location(s) 204 which, in turn, may be able to read and/or have data stored from the computer-readable storage medium 106. Based on this information and/or information from the user interface 104 received by the processor 202, the processor may instruct the display programmed logic circuitry 206 to display an appropriate image on the display 102. Operating information may be programmed into the processor 202, stored in one or more storage locations 204, may be embedded as firmware, etc. Additionally or in the alternative, the display device may be capable of running software for interpreting the design drawings (e.g., a CAD/CAM program, a customized graphics viewing program, etc.).

In certain example embodiments, a design drawing may be read from the computer-readable storage medium 106. The processor 202 may instruct the display programmed logic circuitry 206 to display the drawing on the display 102 according to a default scale stored in the storage location 204. For example, if the design drawing is recognized as pertaining to landscaping, the scale may be set to an “X scale,” wherein 1 in. corresponds to X ft., as is common to the landscaping industry. As another example, if the design drawing is recognized as pertaining to architectural drawings, the scale may be set to an “Y scale,” wherein ¼ in. corresponds to Y ft., as is common to the architectural industry. Of course, it will be appreciated that X and Y are variables, which themselves may be pre-stored and/or specified by the user. It also will be appreciated that other units of measure (e.g., inches, feet, centimeters, meters, etc.) may be used, and other standards may be implemented, employed, and/or customized.

Based on user input to the user interface 104, the processor 202 may instruct display programmed logic circuitry 206 to change the imaged displayed on the display 102. Thus, the processor 202 and/or the display programmed logic circuitry 206 may adjust the image, for example, in terms of scale, position, etc. Thus, a scale for an design drawing at least initially may be common to an appropriate industry, though it may be customizable and/or changeable on-the-fly.

In certain example embodiments, the scaling may be based on one or more computations performed by, for example, the processor 202. By way of example and without limitation, a reference scale may be defined as (design drawing units/pixels)*(pixels per inch of display)*(display units/design drawing units). Design drawing units per pixel commonly is known as a map scale factor. A design drawing scale factor can be calculated, for example, by the formula (maximum ×value for design drawing extent−minimum×value for design drawing extent)/width of design drawing in pixels.

Unlike conventional techniques, by way of example and without limitation, some or all of these values may be input directly by the user or they may be read directly from the sources and/or known in advance. For example, conventional techniques would require a user to input at least the size and/or resolution of the screen when the design drawing is to be displayed on a screen. Currently, in most cases, this is not feasible or even necessary because measurements are not to be taken directly from the screen. Rather, a virtual ruler may be provided for reference without regard to the actual scaling to be used. In the case of word processors, CAD/CAM programs, etc., for example, it is sufficient to provide such a virtual ruler because no measurements will be taken from the screen and a relative scale is suitable for what-you-see-is-what-you-get (WYSIWYG) programs. Moreover, in many cases, the end product is merely a printout, which requires a dots per inch to pixels per inch manipulation, but still requires the paper copies or printouts that were identified as disadvantageous above.

By contrast, in certain example embodiments, the processor 202 may be programmed in advance to perform its calculations based on known parameters (e.g., the display 102 functions at a resolution of 72 pixels per inch, 165 pixels per inch, 300 pixels per inch, etc.; the size of the display is 5″×5″, 10″×10″, etc.). These pre-programmed or known values may be used to determine the proper scale factor and create an image to be displayed accordingly, such that measurements may be taken directly from the screen. In certain other example embodiments where vector-based design drawings are used, it may be possible to appropriately scale the vectors directly to obtain the properly sized resulting design drawing for display on the display device. In still other example embodiments, it may be possible to print directly to an electronic file specifying dots per inch (dpi) with a given scale. In such example embodiments, it may be possible to further specify pixels per inch or to convert between the dpi with scale and the pixels per inch. In certain example embodiments, it may not be necessary to calculate extents, as it may be possible merely to create an image “larger” than the display area of the device and merely “move” around the visible area “over” the image.

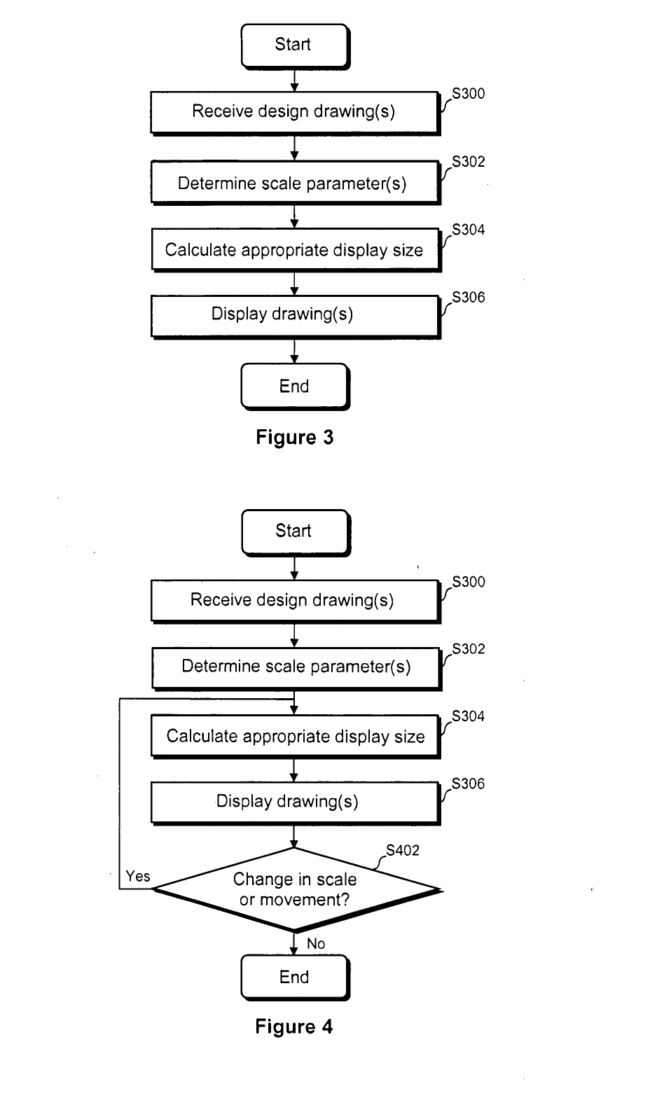

FIG. 3 is an illustrative flowchart for displaying images to scale such that measurements may be taken directly from the display of a device, in accordance with an example embodiment. Design drawings are received by the device in step S300, for example, via a computer-readable storage medium, a computer-based connection or link, etc. Appropriate scale parameters are determined in step S302. Such scale parameters may include, for example, display size, display scale, display resolution, actual design size of the design drawing, design drawing scale, etc. Based at least on the scale parameters, the appropriate display size and/or characteristics may be determined in step S304. Finally, the drawing may be displayed in step S306.

FIG. 4 is an illustrative flowchart for updating images displayed to scale such that measurements may be taken directly from the display of a device, in accordance with an example embodiment. As above, design drawings are received by the device in step S300, for example, via a computer-readable storage medium, or a computer-based connection or link, etc. Appropriate scale parameters are determined in step S302. Based at least on the scale parameters, the appropriate display size and/or characteristics may be determined in step S304. The drawing may be displayed in step S306. If, however, there is additional user input (e.g., a change in scale or movement of the image) in step S402, then the corresponding change to the display parameters (e.g., image to be displayed, scale to be used, area to be shown, etc.) will be taken into account in step S304, and an updated image will be displayed in step S306. If there is no additional user input, the process is (at least temporarily) ended.

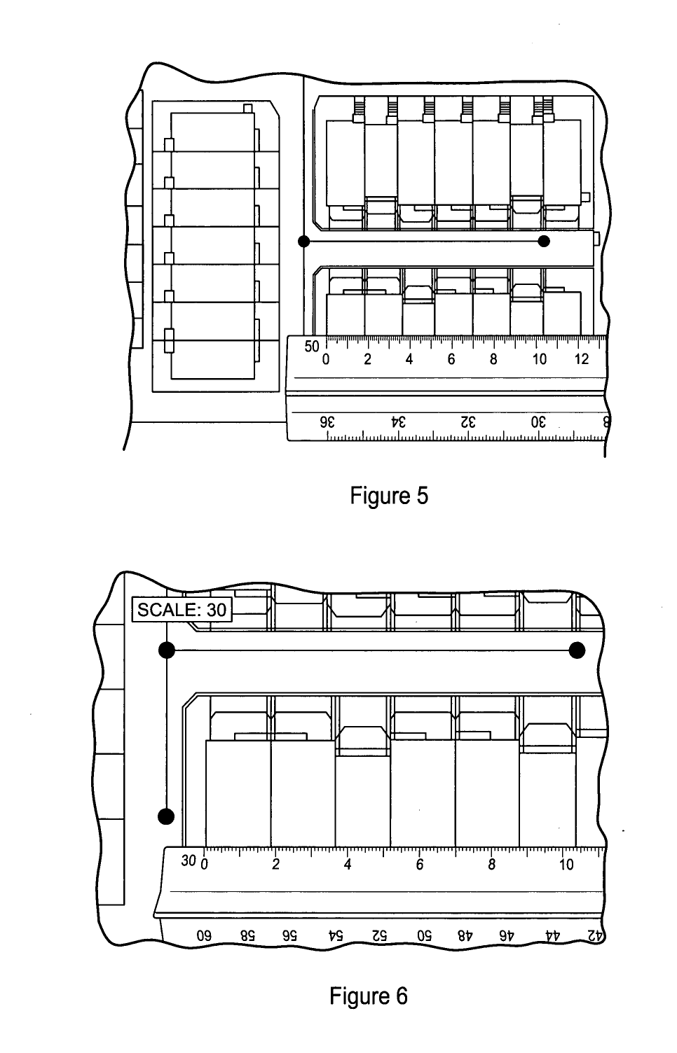

FIG. 5 is an illustrative view of a housing plan displayed on a device such that measurements may be taken directly therefrom, in accordance with an example embodiment. In FIG. 5, the housing plan is displayed in “50 scale,” where 1 inch is equivalent to 50 feet. Each house width has a known value of 18 feet, and this information may be made known to the device before the image is displayed to ensure accurate display. As shown in FIG. 5, a ruler may be placed over the display to take measurements directly therefrom.

FIG. 6 is another illustrative view of a housing plan displayed on a device such that measurements may be taken directly therefrom, in accordance with an example embodiment. Again, each house width has a known value of 18 feet. However, as shown in the upper left-hand corner, the display is in “30 scale,” where 1 inch is equivalent to 30 feet. The scale information optionally may be displayed to the user, as is the case in FIG. 6.

As noted above, a computer-readable storage medium may be provided according to certain example embodiments. It may include at least one design drawing and scale parameters for each of the design drawings stored on the computer readable storage medium. Based at least in part on the at least one design drawing and the scale parameters, a device reading the computer-readable storage medium may cause a display of the device to display the at least one design drawing such that measurements can be taken directly from the display. The computer-readable storage medium may be updatable, e.g., by a computer, via a USB, parallel, serial, or similar link, etc.

It will be appreciated that a single display device may be configured to display multiple images (e.g., 2 or more images) at a time, for example, corresponding to multiple pages, multiple views, etc. Optionally, such a display may be in a split-screen format.

Although the example embodiments described herein have related to a custom device, the present invention is not so limited. For example, the techniques described herein may be applied to any device having a display integrally formed therein such as, for example a laptop, PDA, cell phone, etc. The example embodiments also may be applied to projectors and/or projected images, as well as whiteboards that are capable of displaying images stored on a computer-readable storage medium. Also, it will be appreciated that the term programmed logic circuitry as used herein is intended to include any suitable combination of hardware, software, firmware, and/or the like.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A display device, comprising:
a display for displaying at least one design drawing;
at least one storage location for storing the at least one design drawing to be displayed on the display; and,
display programmed logic circuitry causing the display to display the at least one design drawing based at least in part on one or more scale parameters so that the at least one design drawing is displayed on the display so as to allow measurements to be taken directly from the display.

2. The display device of claim 1, further comprising a user interface for permitting instructions to be provided to the display programmed logic circuitry to adjust the display.

3. The display device of claim 2, wherein the user interface is capable of receiving user input to change the at least one design drawing in terms of scale, viewable area, and/or rotation.

4. The display device of claim 1, wherein the at least one design drawing comprises one or more of a specification, technical schematics, map, schematic, landscape, survey, and/or architectural drawing.

5. The display device of claim 1, wherein the one or more scale parameters comprise one or more of: display size, display scale, display resolution, actual design size of the design drawing, and/or design drawing scale.

6. The display device of claim 1, wherein the display is a slow refresh display.

7. The display device of claim 1, wherein the display is a bi-stable display.

8. The display device of claim 1, wherein the at least one storage location is located on a removable or non-removable computer-readable storage medium.

9. The display device of claim 8, wherein the removable computer-readable storage medium is a flash card, SD card, or USB device.

10. The display device of claim 1, further comprising a port for connection with a device to transmit one or more design drawings.

11. A method of displaying at least one design drawing on the display of a device, the method comprising:
receiving the at least one design drawing;
determining scale parameters including at least the size of the display, scale at which the design drawing is to be displayed, and scale data of the at least one design drawing;
calculating display parameters; and,
displaying the design drawing on the display based at least in part on the display parameters such that the at least one design drawing is displayed on the display so as to allow measurements to be taken directly from the display.

12. The method of claim 11, further comprising:
receiving input from a user interface to adjust the display;
re-calculating the display parameters based on the input; and,
updating the display based at least in part on the re-calculated display parameters.

13. The method of claim 12, wherein the input corresponds to a change in the at least one design drawing in terms of scale, viewable area, and/or rotation.

14. The method of claim 11, wherein the at least one design drawing is a specification, technical schematic, map, schematic, landscape, survey, and/or architectural drawing.

15. The method of claim 11, further comprising displaying the scale used by the display.

16. A computer-readable storage medium, comprising:
at least one design drawing; and,
scale parameters for each said design drawing;
wherein based at least in part on the at least one design drawing and the scale parameters, a device capable of reading the computer-readable storage medium is capable of causing a display of the device to display the at least one design drawing such that measurements can be taken directly from the display.

17. The computer-readable storage medium of claim 16, wherein the computer-readable storage medium is a flash card, SD card, or USB device.

18. The computer-readable storage medium of claim 16, wherein the computer-readable storage medium is updatable.
